(19) United States
(12) Patent Application Publication
(10) Pub. No.: US 2014/0144309 A1
(43) Pub. Date: May 29, 2014

(54) Drumhead Cover System

(71) Applicant: Edward Philip Cawthorne, London (GB)

(72) Inventor: Edward Philip Cawthorne, London (GB)

(21) Appl. No.: 13/685,387

(22) Filed: Nov. 26, 2012

(51) Int. Cl. G10G 7/00; G10D 13/02

(52) U.S. Cl. CPC G10G 7/00; G10D 13/027
USPC 84/411 R

(57) ABSTRACT

A drumhead cover system for use with a drum having a resonant drumhead, the system comprising a drumhead cover being adapted to display imagery and/or text. The drumhead cover comprises means for attaching to a drum such that in use it covers at least part of the drumhead and the cover is attached to the resonant drumhead such that the drumhead cover is spaced from the resonant drumhead.

### BACKGROUND OF THE INVENTION

1. Field of the Invention

This application claims priority to United Kingdom application number GB1120395.7 filed on Nov. 25, 2011, which is incorporated herein in its entirety. The present invention relates to a drumhead cover system.

2. Prior Art

It is conventionally known that live music bands comprise a drummer accompanied by other musicians. A drum kit, also referred to as a drum set, generally comprises an arrangement of various percussion drum and cymbal components, with the bass drum being the largest drum employing for providing the resonant deep toned time keeping rhythm. The bass drum is generally comprised of a drum body, with drumheads engaged to one or both sides of the body via a plurality removable locking hardware including lugs and tightening screws.

In a conventional kit arrangement, the bass drum is positioned as a centerpiece. During stage performances, due to the visibility of the generally large bass drum, bands and musicians will employ the exposed bass drum head for displaying the band name and/or artwork relating to the band. Often the band name or artwork is painted or imparted directly on the exposed drum head in a permanent manner.

Further, it is known that in the world of professional music, top performing musicians having recognizable talent are often sought after to play for different bands. In particular, it is known that many professional drummers will play in many different bands. As such, there is a need for the drummer to change the drum head when performing with different bands, in order to display the correct band name or artwork for a particular performance.

To do so it is necessary for drummers to own different drumheads for their bass drums, with different resonant bass drum heads to display different band names and/or artwork for use with each of the respective bands in which they play. In order to change the resonant bass drumhead it is necessary to unscrew all of the bass drum lugs and replace the first drumhead with a second one, bearing a different band name and/or artwork. The second drumhead must then be secured and tuned. This process is time-consuming, particularly for drummers that play in many different bands an/or need to rapidly change the drumhead between gigs on the same day. The present invention seeks to address this issue.

The forgoing examples of limitations of drum head removal and replacement related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

According to a first preferred mode of the present invention there is provided a drumhead cover system adapted for use with a drum having a resonant drumhead, the system generally comprising:
a. a drumhead cover being adapted to display indicia and;
b. means for attaching the drumhead cover to the resonant drumhead such that in use it covers at least part of the drumhead and the drumhead cover is spaced from the drumhead.

The provision of a system comprising a drumhead cover having means for attaching to a drum allows for a drumhead to be rapidly and easily covered so as to display certain indicia without replacing the drumhead. Further, by attaching the drumhead cover to a drumhead the appearance of the system is aesthetically pleasing.

Even further, by attaching the drumhead cover to the drumhead such that the cover is spaced from the resonant drumhead the sound quality of the drum is not adversely affected. Preferably the means for attaching the drumhead cover to the drumhead comprises at least one magnet and a metallic body, or other suitable means. Employment of at least one magnet allows for the drumhead cover to be readily attached to and removed from the drum.

In other preferred modes however, the means for attaching the drumhead cover to the drumhead comprises a plurality of magnets and one or a plurality of metallic bodies. Employment of a plurality of magnets provides a means for enhanced engagement of the drumhead cover to the drumhead and ensures that the drumhead cover does not come loose when the system is in use. Preferably the drumhead cover is configured with suitable locations for positioning a plurality of magnets such that the plurality of magnets can be engaged directly to the drumhead cover.

The provision of a metallic body allows for an attachment means that corresponds with the employment of the magnets. In use, it is preferred that the metallic body or bodies are engageable to the drumhead. Therefor the metallic body or bodies being engageable to the drumhead, and the cover comprising one or a plurality of magnets, allows the drumhead cover to be selectively attached to the drumhead as needed.

In at least one preferred mode, the metallic body is adapted to communicate around least part of the periphery of the drumhead. This therefor ensures that the sound of the drum is not adversely affected. For example, in accordance with at least one preferred mode, the metallic body comprises a ring of metal adapted to communicate around the periphery of the drumhead. This configuration is exceptionally ideal as an attachment means for a plurality of magnets. Further, as a means to ensure the sound of the drum is not adversely affected, at least one layer of foam is preferably employed between the metallic body and the drumhead.

The provision of a layer of foam between the metallic body and the drumhead provides a suitable means for attaching the metallic body to the drumhead, via adhesives or the like, and when used in an appropriate form can provide a dampening of the drum, thus doing away with the need for separate dampening means inside the drum.

Further, it is preferred that the drumhead cover of the present invention is substantially circular, as conventional drumheads are known to be circular and can therefor provide the most suitable means for covering the drumhead for displaying the band name or artwork.

In some modes, the drumhead cover is adapted to substantially cover the whole drumhead as this has been shown to provide most aesthetically pleasing configuration.

In at least one preferred mode, the drumhead cover comprises printed indicia. Text and or imagery may be easily printed onto a drumhead cover, providing a low-cost and readily available display means.

In yet another preferred mode the drumhead cover comprises means for electronically displaying indicia. The use of an electronic display on the drumhead cover provides a means for changing text and/or imagery electronically, doing away with the need for a plurality of drumhead covers.

In still yet another preferred mode, the device is provideable in a kit comprises a plurality of drumhead covers. When printed text and/or imagery is used it may be desirable to have a plurality of drumhead covers so as to allow for a plurality of different indicia to be displayed when needed.

According to yet another preferred mode of the present invention there is provided a drumhead cover adapted for use with a drumhead cover system adapted for use with a drum having a resonant drumhead, the system comprising: a drumhead cover being adapted to display indicia; and means for attaching the drumhead cover to the resonant drumhead such that in use it covers at least part of the drumhead and the drumhead cover is spaced from the drumhead.

According to still yet another preferred mode of the present invention there is provided a drumhead cover attachment means adapted for use with a drumhead cover system adapted for use with a drum having a resonant drumhead, the system comprising: a drumhead cover being adapted to display indicia; and means for attaching the drumhead cover to the resonant drumhead such that in use it covers at least part of the drumhead and the drumhead cover is spaced from the drumhead

According to still another preferred mode of the present invention there is provided a drum having a resonant drumhead and a drumhead cover system, the system comprising: a drumhead cover being adapted to display indicia; and means for attaching the drumhead cover to the resonant drumhead such that in use it covers at least part of the drumhead and the drumhead cover is spaced from the drumhead.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects, features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 is an exploded perspective view of a system made in accordance with the present invention.

FIG. 2 is a schematic cross-section of a drumhead cover for use in accordance with the system of the present invention.

FIG. 3 is a plan view of the drumhead cover of FIG. 2.

FIG. 4 is a schematic side view of a drumhead cover attachment ring for use in accordance with the system of the present invention, the ring being attached to a drumhead.

FIG. 5 is a plan view of the drumhead cover attachment ring of FIG. 4.

FIG. 6 is a schematic diagram showing how the drum head cover of FIG. 2 may be attached to a drum that comprises the attachment ring of FIG. 4.

FIG. 7 is a schematic cross-section of the drumhead cover of FIG. 2 attached to the attachment ring of FIG. 4.

### DETAILED DESCRIPTION OF THE EMBODIMENTS OF THE INVENTION

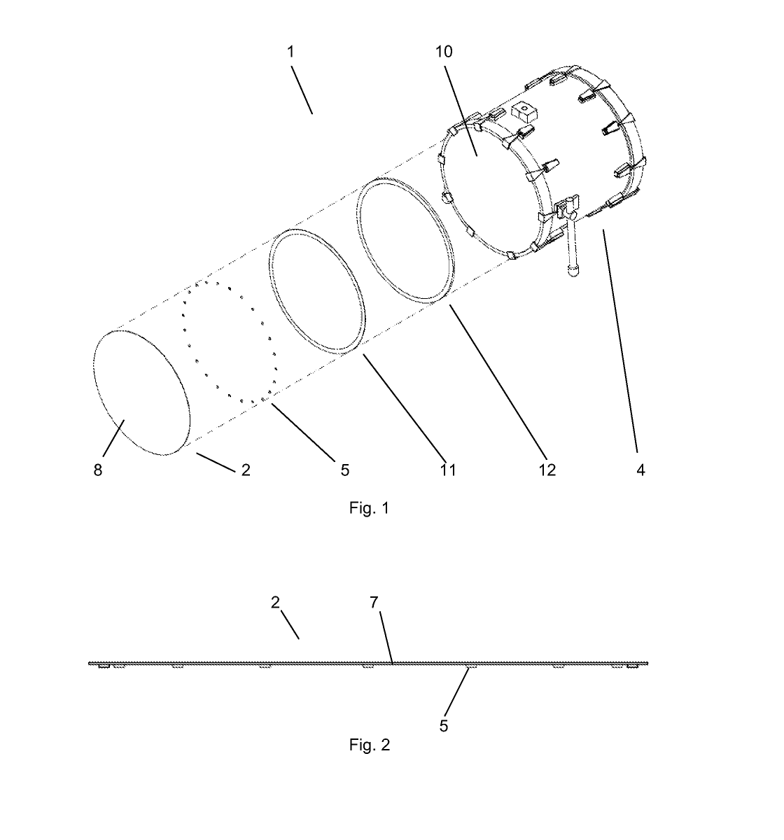

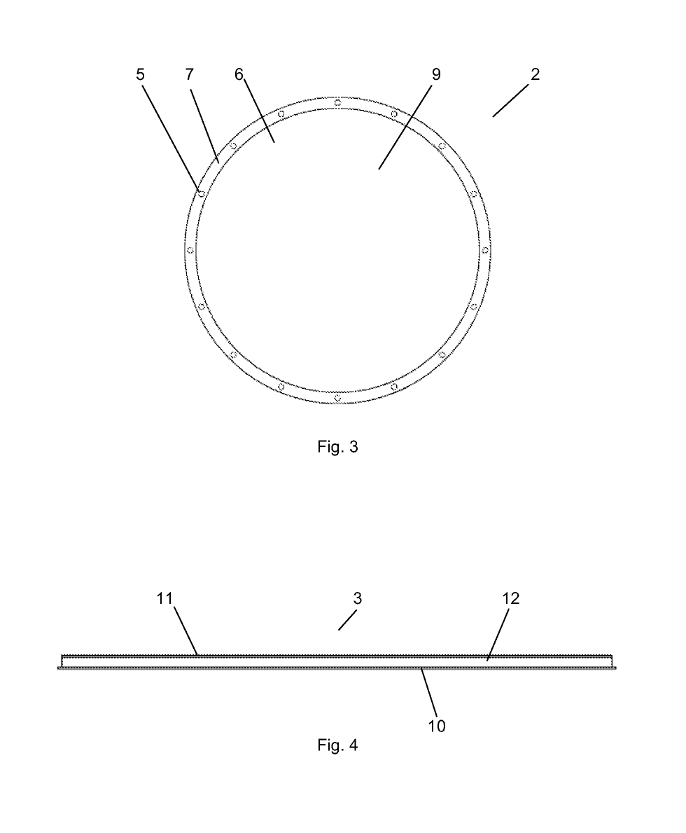

Referring to the drawings in FIGS. 1-7, there is provided a particularly preferred mode of the drumhead cover system 1 comprising generally a drumhead cover 2 and a drumhead cover attachment ring 3 for use with a bass drum 4. The drumhead cover 2 is circular and comprises a polyester film 6 attached adjacent to its periphery to plastic ring 7. Plastic ring 7 defines the periphery of drumhead cover 2. Plastic ring 7 comprises a plurality of disc magnets 5 distributed evenly around its circumference and thus the circumference of drumhead cover 2. In the present embodiment N42 grade NiCuNi disc magnets of 0.4 kg strength may be used. Disc magnets 5 protrude around 1 mm from plastic ring 7.

It is noted that upon reading this disclosure, those skilled in the art will recognize that any suitable strength, number and positioning of magnets may be employed.

The polyester film 6 of drumhead cover 2 has an outwardly facing side 8 onto which a band name and/or artwork indicia (not shown) is printed. Outwardly facing side 8 is the side that faces an audience when the drumhead cover is in use. The polyester film 6 of drumhead cover 2 has an inwardly facing side 9, which faces the drumhead 10 of drum 4 when drumhead cover 2 is in use.

In some modes, the polyester film 6 may comprise a microphone port, i.e. a hole, adapted to align with a microphone port on a drumhead through which a microphone may be placed when the drum is in use and amplification is required. Such a microphone port is not shown in the Figures of the present application, but how it might be configured will be apparent to any person skilled in the art.

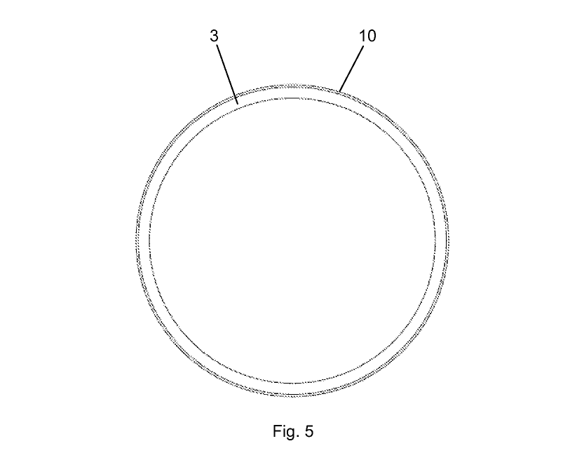

Referring now to FIGS. 4 and 5, the drumhead cover attachment ring 3 shown in these Figures is attached to resonant drumhead 10. The drumhead cover attachment ring 3 comprises a foam ring 12 and a steel ring 11. The foam ring 12 is of a size such that when it is fitted to drumhead 10 communicates circumferentially adjacent to the perimeter of drumhead 10. In the present mode, the foam ring 12 is 10 mm deep with a 550 mm outside diameter, 530 mm inside diameter (20 mm thick) and a density of 150 Kg/m3. However it is noted that other suitable materials and values of thicknesses and density may be employed and are considered part of this disclosure. In addition, in the present mode, the foam ring 12 is attached to drumhead 10 by means of adhesive however other suitable means may be employed and are anticipated.

Attached to the foam ring 12 is steel ring 11, which faces outwardly from a drum 4 when attachment ring 3 is attached to drumhead 10. It will be apparent that although in the present embodiment foam ring 12 runs continuously around the periphery of drumhead cover attachment ring 3, in other embodiments the foam need not be continuous, but separate sections of foam could be employed.

In the present mode the steel ring 11 is around 1 mm in thickness and has the same outside and inside diameters as foam ring 12. Steel ring 11 is attached to foam ring 11 by means of adhesive.

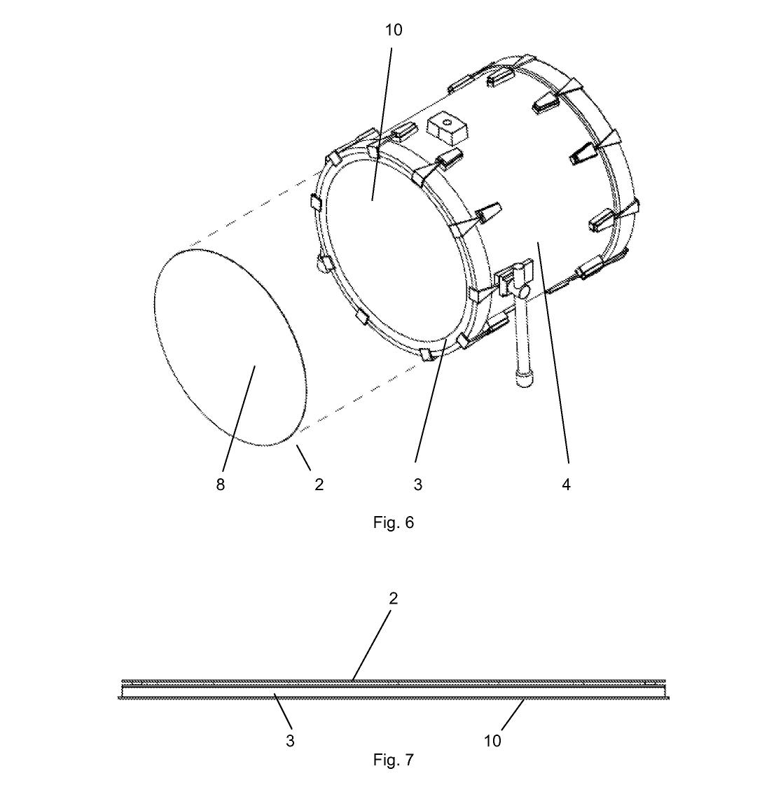

Turning to the system of the present invention in use and referring to FIGS. 6 and 7, the drumhead cover attachment ring 3 is attached to a resonant drumhead 10 of a drum 4 with which the system is to be used. The drumhead cover 2 may then be attached to drumhead cover attachment ring 3 by means of magnets 5 attaching to steel ring 11. The drumhead 10 is thereby covered by drumhead cover 2, and the band name and/or artwork on outwardly facing side 8 of drumhead cover 2 may be displayed to an audience.

When the user wishes to change the band name and/or artwork displayed on drum 4 they may simply remove the drumhead cover 2 and replace it with an alternative drumhead cover bearing a different band name and/or artwork. Thus, the invention dispenses with the need to repeatedly change and tune resonant drumheads. Furthermore, another advantage to a user of the presently disclosed system is a reduction in the cost of owning multiple printed resonant drumheads. The changeable drumhead covers are cheaper to manufacture and print on. Thus the system represents better value for money than individually printed resonant heads.

It will be apparent that in some circumstances if a user has a drumhead with indicia printed on it (and they only require two different indicia to be displayed) they may only require a single drumhead cover, which can be used to display indicia different to those on the drumhead. It will be apparent that many means of attachment of a drumhead cover to a drum could be employed, but it is believed that the present embodiment has particular advantages.

Firstly, the drumhead cover attachment ring 3 and magnets 5 create an 12 mm gap between drumhead cover 2 and resonant drumhead 10 resulting in resonant drumhead 10 being able to resonate freely when the drum is struck on the batter side. Thus, by attaching the drumhead cover to the resonant drumhead such that the cover is spaced from the drumhead, the quality of the sound produced by the resonant drumhead is not noticeably diminished.

Furthermore, foam ring 12 that is attached to resonant drumhead 10 replaces any need for internal dampening of drumhead 10 within drum 4. Additionally a microphone port (not shown) in both drumhead cover 2 in combination with the 1 mm gap between drumhead cover 2 and steel ring 11 created by magnets 5, allows air to sufficiently move when resonant drumhead 10 vibrates as a result of the batter head of the drum being struck.

It is noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A drumhead cover system adapted for use with a drum having a resonant drumhead, the system comprising:
a drumhead cover being adapted to display indicia; and
means for attaching the drumhead cover to the resonant drumhead such that in use it covers at least part of the drumhead and the drumhead cover is spaced from the drumhead.

2. The system of claim 1 wherein the means for attaching the drumhead cover to the drumhead comprises at least one magnet.

3. The system of claim 1 wherein the means for attaching the drumhead cover to the drumhead comprises at plurality of magnets.

4. The system of claim 3 wherein the plurality of magnets is located on the drumhead cover.

5. The system of claim 2 wherein the means for attaching the drumhead cover to the drumhead comprises at least one metallic body.

6. The system of claim 5 wherein the metallic body is adapted to run around at least part of the periphery of the drumhead.

7. The system of claim 5 wherein the metallic body comprises a ring of metal adapted to run around the periphery of the drumhead.

8. The system of claim 1 wherein the metallic body is adapted to be connected to the drumhead via at least one layer of foam.

9. The system of claim 1 wherein the drumhead cover is substantially circular.

10. The system of claim 1 wherein the drumhead cover is adapted to substantially cover the whole drumhead.

11. The system of claim 1 wherein the drumhead cover comprises printed indicia.

12. The system of claim 1 wherein the drumhead cover comprises means for electronically displaying indicia.

13. The system of claim 1 comprising a plurality of drumhead covers.

14. A drumhead cover adapted for use with the system according to claim 1.

15. A drumhead cover attachment means adapted for use with the system according to claim 1.

16. A drum comprising the system of claim 1.
